(19) United States
(12) Patent Application Publication
(10) Pub. No.: US 2010/0218110 A1
(43) Pub. Date: Aug. 26, 2010

(54) METHODS AND SYSTEMS FOR DISPLAYING USER INTERFACES ON REMOTE DEVICES

(76) Inventor: Jie Yao, Shanghai (CN)

Correspondence Address: JONES DAY, 222 EAST 41ST ST, NEW YORK, NY, 10017, US

(21) Appl. No.: 12/408,572

(22) Filed: Mar. 20, 2009

(30) Foreign Application Priority Data
Feb. 24, 2009 (CN) 200910007290.1

(51) Int. Cl. G06F 3/01

(52) U.S. Cl. 715/744

(57) ABSTRACT

Method and system for displaying a user interface on a remote device. The method includes receiving a first signal from a remote device by a computer server. The first signal is associated with a uniform resource locator request. The computer server includes at least a user interface engine and a skin engine. Additionally, the method includes running a user interface script by the user interface engine, importing to the skin engine from the user interface engine at least a skin name and one or more user interface elements based on at least information associated with the user interface script, and determining by the skin engine, availability of a skin based on at least information associated with the skin name. The skin corresponds to a skin folder with a folder name, and the folder name corresponds to the skin name. The folder includes at least one or more dynamic html templates.

### 1. CROSS-REFERENCES TO RELATED APPLICATIONS

This application claims priority to Chinese Patent Application No. 200910007290.1, filed Feb. 24, 2009, commonly assigned, incorporated by reference herein for all purposes.

### 2. COPYRIGHT NOTICE

A portion of this application contains computer codes, which are owned by eBao Corporation. All rights have been preserved under the copyright protection, eBao Corporation ©2009.

### 3. BACKGROUND OF THE INVENTION

The present invention is directed to user interfaces. More particularly, the invention provides methods and systems for generating skins and/or using skins to display user interfaces. Merely by way of example, the invention has been applied to displaying interfaces through web browsers. But it would be recognized that the invention has a much broader range of applicability.

Many software applications are capable of displaying interfaces for user interactions. The user interfaces often provide a set of controls, such as text input controls, calendar input controls, and button controls. Through these controls, the users can interact with the software applications, such as web browsers.

Even for the same software application, different users may prefer different interface appearances. For example, a user may like to display a special logo at the top of the interface, display a special background color for the interface, and/or display special shapes for input boxes and/or buttons. As a result, the “skin” technology has been developed for software applications.

The conventional “skin” technology can use a skin definition file and define the appearance of an interface control. For example, the interface control is a text input control, a calendar input control, or a button control. In another example, the appearance of the interface control includes length, width, color, and/or background images. Specifically, for web-based applications, the skin is defined in a common style sheet, based on which, the interface appearance can be changed.

Although the common style sheet can be used to change the interface appearance, it often lacks in flexibility. For example, the conventional “skin” technology often cannot effectively control the border of an interface control, a logo at the top of the user interface, and/or certain output elements of an user interface. Hence it is highly desirable to improve techniques for displaying user interfaces.

### 4. BRIEF SUMMARY OF THE INVENTION

The present invention is directed to user interfaces. More particularly, the invention provides methods and systems for generating skins and/or using skins to display user interfaces. Merely by way of example, the invention has been applied to displaying interfaces through web browsers. But it would be recognized that the invention has a much broader range of applicability.

According to one embodiment, a method for displaying a user interface on a remote device includes receiving a first signal from a remote device by a computer server. The first signal is associated with a uniform resource locator request. The computer server includes at least a user interface engine and a skin engine. Additionally, the method includes running a user interface script by the user interface engine, importing to the skin engine from the user interface engine at least a skin name and one or more user interface elements based on at least information associated with the user interface script, and determining by the skin engine, availability of a skin based on at least information associated with the skin name. The skin corresponds to a skin folder with a folder name, and the folder name corresponds to the skin name. The folder includes at least one or more dynamic html templates. Moreover, the method includes, if the skin is determined to be available, decorating the one or more user interface elements by the skin engine based on at least information associated with the one or more dynamic html templates, and sending a second signal from the computer server to the remote device. The second signal is associated with the one or more decorated user interface elements for displaying a first user interface on the remote device.

According to another embodiment, a computer server for displaying a user interface on a remote device includes a user interface engine, a skin engine, and a skin database coupled to the skin engine. The user interface engine is configured to receive a first signal associated with a uniform resource locator request from a remote device, and run a user interface script. The skin engine is configured to import from the user interface engine at least a skin name and one or more user interface elements based on at least information associated with the user interface script, and determine availability of a skin based on at least information associated with the skin name. The skin corresponds to a skin folder with a folder name, and the folder name corresponds to the skin name. The skin folder includes at least one or more dynamic html templates. Additionally, the skin engine is further configured to, if the skin is determined to be available, decorate the one or more user interface elements based on at least information associated with the one or more dynamic html templates. Moreover, the user interface engine is further configured to, if the skin is determined to be available, send a second signal associated with the one or more decorated user interface elements for displaying a first user interface on the remote device.

According to yet another embodiment, a computer program product includes a computer readable medium including instructions for displaying a user interface on a remote device. The computer readable medium includes one or more instructions for receiving information associated with a uniform resource locator request from a remote device, one or more instructions for running a user interface script, one or more instructions for transferring at least a skin name and one or more user interface elements based on at least information associated with the user interface script, and one or more instructions for determining availability of a skin based on at least information associated with the skin name. The skin corresponds to a skin folder with a folder name, and the folder name corresponds to the skin name. The skin folder includes at least one or more dynamic html templates. Additionally, the computer readable medium includes one or more instructions for, if the skin is determined to be available, decorating the one or more user interface elements based on at least information associated with the one or more dynamic html templates, and outputting information associated with the one or more decorated user interface elements for displaying a user interface on the remote device.

Many benefits are achieved by way of the present invention over conventional techniques. Certain embodiments of the present invention provide a skin engine and define a skin with a skin name and a skin folder. For example, the skin folder includes at least one or more dynamic html templates. In another example, the skin engine can decorate imported user interface elements with the skin and output the decorated user interface elements.

Depending upon embodiment, one or more of these benefits may be achieved. These benefits and various additional objects, features and advantages of the present invention can be fully appreciated with reference to the detailed description and accompanying drawings that follow.

### 5. BRIEF DESCRIPTION OF THE DRAWINGS

FIG. 1 is a simplified diagram showing a system for displaying one or more user interfaces on one or more remote devices according to an embodiment of the present invention;

FIG. 2 is a simplified diagram showing the system for displaying one or more user interfaces on one or more remote devices according to another embodiment of the present invention;

FIG. 3 is a simplified diagram showing certain components of the skin engine according to an embodiment of the present invention;

FIG. 4 is a simplified diagram showing a method for displaying one or more user interfaces on one or more remote devices according to an embodiment of the present invention;

FIG. 5 is a simplified diagram showing a method for loading a skin by skin name and determining availability of skin according to an embodiment of the present invention;

FIG. 6 is a simplified diagram showing a method for generating and saving a skin that can be used for displaying one or more user interfaces on one or more remote devices according to an embodiment of the present invention;

FIG. 7 is a simplified diagram showing components of a skin that is generated according to an embodiment of the present invention;

FIGS. 8 and 9 are simplified diagrams showing a match between certain user interface controls and certain dynamic html templates as parts of a skin that is generated according to an embodiment of the present invention;

FIGS. 10, 11, and 12 are simplified diagrams showing user interface (UI) elements outputted by the method for displaying one or more user interfaces on one or more remote devices according to certain embodiments of the present invention;

FIG. 13 is a simplified diagram showing an exemplary application of the method for displaying one or more user interfaces on one or more remote devices according to an embodiment of the present invention;

FIGS. 14-21 are simplified diagrams showing computer codes for various dynamic html templates that can be used for a skin generated according to certain embodiments of the present invention.

### 6. DETAILED DESCRIPTION OF THE INVENTION

The present invention is directed to user interfaces. More particularly, the invention provides methods and systems for generating skins and/or using skins to display user interfaces. Merely by way of example, the invention has been applied to displaying interfaces through web browsers. But it would be recognized that the invention has a much broader range of applicability.

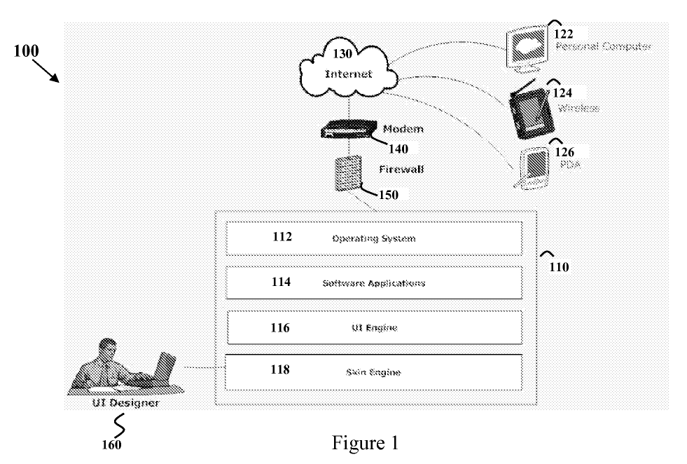

FIG. 1 is a simplified diagram showing a system for displaying one or more user interfaces on one or more remote devices according to an embodiment of the present invention. This diagram is merely an example, which should not unduly limit the scope of the claims. One of ordinary skill in the art would recognize many variations, alternatives, and modifications. The system 100 includes remote devices 122, 124, and 126, and a server 110, which includes an operating system 112, software applications 114, an user interface (UI) engine 116, and a skin engine 118. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

As shown in FIG. 1, the remote devices 122, 124, and 126 can interact with the server 110 through the Internet 130, a modem 140, and a firewall 150 according to an embodiment. The remote devices 122, 124, and 126 are a personal computer, a wireless device, and a personal data assistant (PDA) device, respectively. For example, each of the remote devices 122, 124, and 126 is installed with a web browser. In another example, the wireless device 124 is a mobile phone. In yet another example, the wireless device 124 communicates with the server 110 through the Internet 130 and a wireless network.

According to another embodiment, the server 110 is a web server, which also includes a skin database. According to yet another embodiment, the server 110 is a computer server, which also includes a skin database. According to yet another embodiment, the user interface (UI) engine 116 includes one or more software modules. According to yet another embodiment, the skin engine 118 includes one or more software modules.

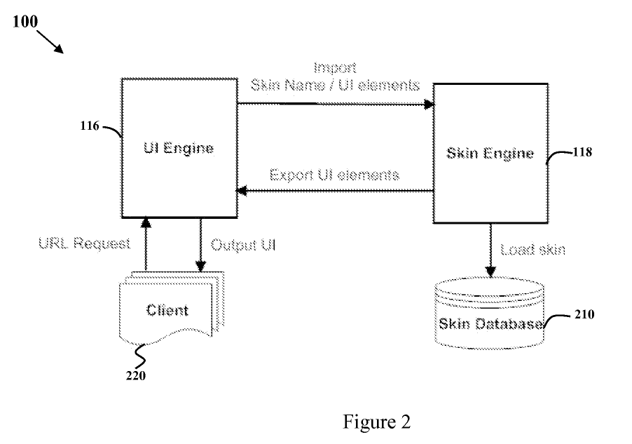

FIG. 2 is a simplified diagram showing the system 100 for displaying one or more user interfaces on one or more remote devices according to another embodiment of the present invention. This diagram is merely an example, which should not unduly limit the scope of the claims. One of ordinary skill in the art would recognize many variations, alternatives, and modifications. The system 100 includes a user interface (UI) engine 116, a skin engine 118, a skin database 210, and one or more client devices 220. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to an embodiment, the skin database 210 is a part of the server 110. For example, the server 110 also includes at least the user interface (UI) engine 116 and the skin engine 118. According to another embodiment, the one or more client devices 220 include the remote devices 122, 124, and/or 126. As shown in FIG. 2, the client devices 220 is configured to interact with the UI engine 116 directly, or indirectly through at least the Internet 130, the modem 140, and/or the firewall 150. Also, the UI engine 116 is further configured to interact with, for example, the operating system 112, the software applications 114, and/or the skin engine 118. In another example, the skin engine 118 is configured to interact with the operating system 112, the software applications 114, the UI engine 116, and/or the skin database 210.

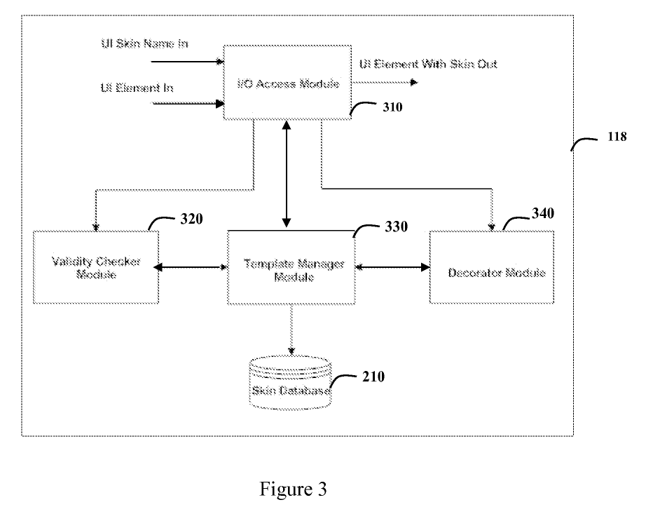

FIG. 3 is a simplified diagram showing certain components of the skin engine 118 according to an embodiment of the present invention. This diagram is merely an example, which should not unduly limit the scope of the claims. One of ordinary skill in the art would recognize many variations, alternatives, and modifications. The skin engine 118 includes an input/output (I/O) access module 310, a validity checker module 320, a template manager module 330, and a decorator module 340. Although the above has been shown using a selected group of components for the skin engine, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

The I/O access module 310 is configured to receive the input from the UI engine 116 and send the output to the UI engine 116. According to an embodiment, the I/O access module 310 is further configured to interact with the validity checker module 320 and/or the decorator module 340. According to another embodiment, both the validity checker module 320 and the decorator module 340 are configured to interact with the template manger module 330, which can also interact with the skin database 210.

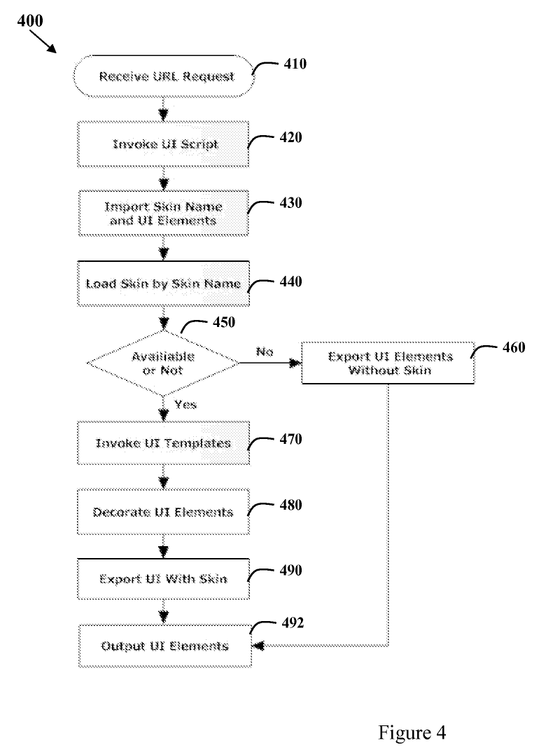

FIG. 4 is a simplified diagram showing a method for displaying one or more user interfaces on one or more remote devices according to an embodiment of the present invention. This diagram is merely an example, which should not unduly limit the scope of the claims. One of ordinary skill in the art would recognize many variations, alternatives, and modifications. The method 400 includes process 410 for receiving a uniform resource locator (URL) request, process 420 for invoking a user interface (UI) script, process 430 for importing a skin name and one or more user interface (UI) elements, process 440 for loading a skin by the skin name, process 450 for determining availability of the skin, process 460 for exporting one or more user interface (UI) elements without skin, process 470 for invoking one or more user interface (UI) templates, process 480 for decorating one or more user interface (UI) elements, process 490 for exporting one or more user interface (UI) elements with skin, and process 492 for outputting one or more user interface (UI) elements. Although the above has been shown using a selected group of processes for the method, there can be many alternatives, modifications, and variations. For example, the processes 440 and 450 are combined. Other processes may be inserted to those noted above. Depending upon the embodiment, the sequence of processes may be interchanged with others replaced. As an example, some or all processes of the method are performed by a computer or a processor directed by a code. In another example, some or all processes of the method are performed according to instructions included by or stored in a computer-readable medium in a computer program product. In yet another example, the method 400 is performed automatically. In yet another example, the method 400 is performed by the server 110. Further details of these processes are found throughout the present specification.

At the process 410, a uniform resource locator (URL) request is received by the server 110 from a client device, such as the remote device 122, 124, or 126. For example, the URL request is received by the UI engine 116 as a part of the server 110. At the process 420, a user interface (UI) script is invoked by the UI engine 116. In one embodiment, the UI script is run to generate one or more user interface (UI) elements and/or a skin name. For example, the UI script is a computer software program. In another example, the UI script includes one or more computer software codes. In yet another example, the one or more UI elements include a text input box, a calendar input box, and/or a button. In yet another example, the skin name is a name for a skin that the UI script requests to decorate the one or more UI elements.

At the process 430, a skin name and one or more user interface (UI) elements are imported by the skin engine 118 from the UI engine 116. For example, the skin name and the one or more UI elements all are generated by the UI script at the process 420. In another example, the skin name and the one or more UI elements are imported by the I/O access module 310 as a part of the skin engine 118.

At the process 440, a skin is attempted to be loaded based on the skin name by the skin engine 118, and at the process 450, the availability of the skin based on the skin name is determined by the skin engine 118. If the skin is determined to be available, the skin is loaded by the skin engine 118. If the skin is determined to be unavailable, the skin is not loaded by the skin engine 118. For example, the loading of the skin includes one or more interactions with the skin database 210. In another example, the skin corresponds to a folder, which has a name that is the same as the skin name and/or matches with the skin name. In one embodiment, the folder includes one or more cascading style sheet files, one or more images and/or icons, and one or more dynamic html templates.

If the skin is determined to be unavailable and the skin is not loaded, the process 460 is performed. At the process 460, one or more user interface (UI) elements are exported without skin from the skin engine 118 to the UI engine 116. For example, the one or more UI elements without skin are exported from the I/O access module as a part of the skin engine 118. In another example, the one or more exported UI elements without skin are the same as the one or more UI elements that are imported at the process 430.

If the skin is determined to be available and the skin is loaded, the process 470 is performed. At the process 470, one or more user interface (UI) templates are invoked by the skin engine 118. More specifically, for example, the one or more UI templates are invoked by the template manager module 330 as a part of the skin engine 118. In another example, the one or more UI templates are one or more dynamic html templates. According to one embodiment, the one or more dynamic html templates include a page resource template, a page top template, a fields section template, a field box template, a list section template, a buttons section template, a button box template, and/or a page bottom template.

At the process 480, the one or more imported user interface (UI) elements are decorated with the one or more invoked UI templates by the skin engine 118. For example, the one or more imported UI elements are decorated by the decorator module 340 as a part of the skin engine 118. In another example, the one or more invoked UI templates are one or more dynamic html templates. In yet another example, the one or more imported UI elements are decorated and thus become one or more UI elements with skin.

At the process 490, one or more user interface (UI) elements with skin are exported from the skin engine 118 to the UI engine 116. For example, the one or more UI elements with skin are exported from the I/O access module 310 as part of the skin engine 118. In another example, the one or more UI elements with skin are generated at the process 480.

At the process 492, the one or more exported UI elements are outputted from the server 110 to a client device. For example, the one or more UI elements are exported at the process 460. In another example, the one or more UI elements are exported at the process 490. According to one embodiment, the one or more exported UI elements are outputted from the UI engine as a part of the server 110. According to another embodiment, the client device is the one from which the server 110 receives the URL request at the process 410. According to yet another embodiment, at the process 492, the one or more exported UI elements are outputted from the server 110 and a corresponding user interface is displayed on the client device.

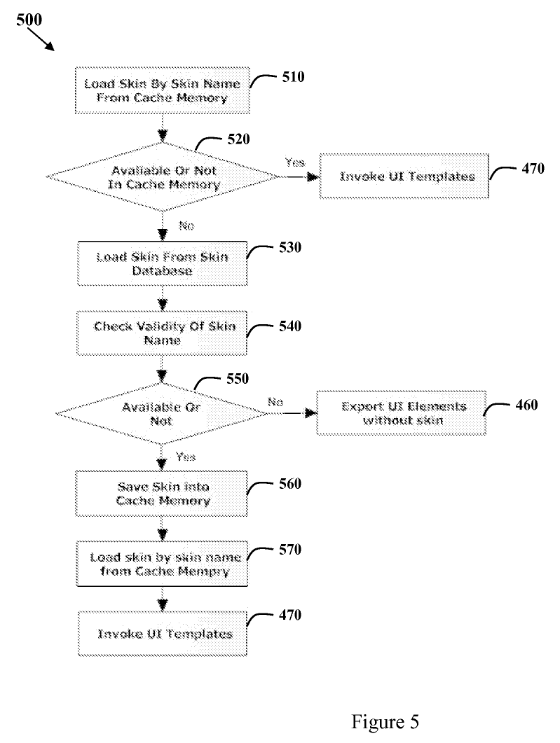

FIG. 5 is a simplified diagram showing a method for loading a skin by skin name and determining availability of skin according to an embodiment of the present invention. This diagram is merely an example, which should not unduly limit the scope of the claims. One of ordinary skill in the art would recognize many variations, alternatives, and modifications. The method 500 includes process 510 for loading a skin by skin name from cache memory, process 520 for determining availability of the skin in the cache memory, process 530 for loading the skin from a skin database, process 540 for checking validity of the skin name, process 550 for determining availability of the skin in the skin database, process 560 for saving the skin in the cache memory, and process 570 for loading the skin by skin name from cache memory. For example, the method 500 is a combination of the process 440 and the process 450.

Although the above has been shown using a selected group of processes for the method 500, there can be many alternatives, modifications, and variations. For example, the processes 510 and 520 are combined. In another example, the processes 530, 540, and 550 are combined. Depending upon the embodiment, the sequence of processes may be interchanged with others replaced. As an example, some or all processes of the method are performed by a computer or a processor directed by a code. In another example, some or all processes of the method are performed according to instructions included by or stored in a computer-readable medium in a computer program product. In yet another example, the method 500 is performed automatically. In yet another example, the method 500 is performed by the skin engine 118. Further details of these processes are found throughout the present specification.

At the process 510, a skin is attempted to be loaded from cache memory based on a skin name, and at the process 520, availability of the skin in the cache memory is determined. If the skin is determined to be available in the cache memory, the skin is loaded by the skin engine 118, and, as an example, the process 470 is also performed. If the skin is determined to be unavailable in the cache memory, the skin is not loaded by the skin engine 118, and subsequently the process 530 is performed. In one embodiment, the skin name is imported by the skin engine 118 from the UI engine 116 at the process 430. In another embodiment, the cache memory is a part of the template manager module 330. In yet another embodiment, the skin corresponds to a folder, which has a name that is the same as the skin name and/or matches with the skin name. For example, the folder includes one or more cascading style sheet files, one or more images and/or icons, and one or more dynamic html templates.

At the process 530, the skin is attempted to be loaded from a skin database based on the skin name, at the process 540, the validity of the skin name is checked, and at the process 550, availability of the skin in the skin database is determined. In one embodiment, the skin is attempted to be loaded based on the skin name by the template manager module 330, which is a part of the skin engine 118. In another embodiment, the validity of the skin name is checked by the validity checker module, which also is a part of the skin engine 118.

For example, the validity of the skin name is checked by comparing the skin name with a valid list of skin names. In another example, the skin database is the skin database 210. According to one embodiment, if the skin name is determined to be invalid, the skin is determined to be unavailable at the process 550. According to another embodiment, if the skin name is determined to be valid, the skin is determined, for example, to be available at the process 550.

If the skin is determined to be unavailable at the process 550, the process 460 is performed. If the skin is determined to be available at the process 550, the processes 560 and 570 are performed. At the process 560, the skin is retrieved from the skin database, such as the skin database 210, and is saved into the cache memory. For example, the process 560 is performed by the template manager module 330, which is a part of the skin engine 118. In another example, the cache memory is a part of the template manager module 330.

At the process 570, the skin is loaded from cache memory based on the skin name by the skin engine 118. For example, the skin corresponds to a folder, which has a name that is the same as the skin name and/or matches with the skin name. In one embodiment, the folder includes one or more cascading style sheet files, one or more images and/or icons, and one or more dynamic html templates. In another example, after the process 570, the process 470 is performed for invoking one or more UI templates, such as one or more dynamic html templates.

As discussed above and further emphasized here, the method 400 is performed by the server 110 according to an embodiment, and the method 500 is performed by the skin engine 118 according to another embodiment of the present invention. For example, the processes 430, 460, and 490 are performed at least in part by the I/O access module 310, the processes 470 and 480 are performed by the decorator module 340. In another example, the processes 510, 520, 530, 550, 560, and 570 are performed by the template manager module 330, and the process 540 is performed by the validity checker module 320.

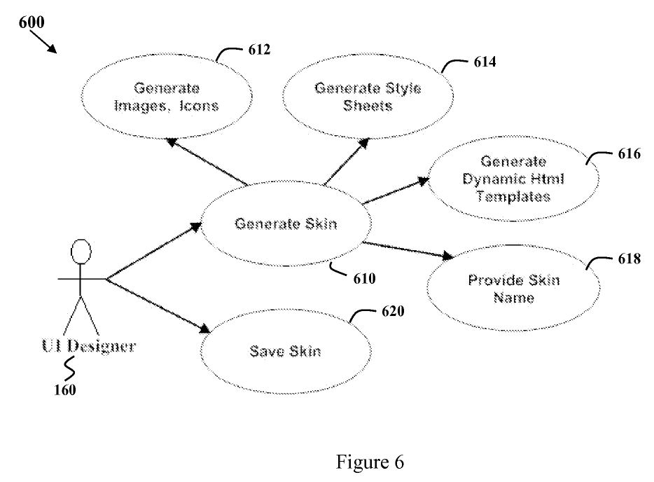

FIG. 6 is a simplified diagram showing a method for generating and saving a skin that can be used for the method 400 according to an embodiment of the present invention. This diagram is merely an example, which should not unduly limit the scope of the claims. One of ordinary skill in the art would recognize many variations, alternatives, and modifications. The method 600 includes process 610 for generating a skin and process 620 for saving a skin. The process 610 includes process 612 for generating one or more images and/or icons, process 614 for generating one or more style sheets, process 616 for generating one or more dynamic html templates, and process 618 for providing a skin name. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. Further details of these processes are found throughout the present specification.

At the process 610, a skin is generated by performing the processes 612, 614, 616 and 618. At the process 612, one or more images and/or icons are generated. At the process 614, one or more style sheets are generated. For example, the one or more style sheets are generated in the form of one or more cascading style sheet files respectively.

At the process 616, one or more dynamic html templates are generated. In one embodiment, the one or more html templates are generated by FreeMarker, a template engine that has the ability to generate text and/or html outputs. In another embodiment, the one or more dynamic html templates include one or more page resource templates, one or more page top templates, one or more fields section templates, one or more field box templates, one or more list section templates, one or more buttons section templates, one or more button box templates, and/or one or more page bottom templates. In yet another embodiment, different types of html templates have different functions respectively. For example, a page resource template can be used to import cascading style sheet files and JavaScript files for the current page. In another example, a field template can be used to decorate a field element, by, for example, adding html elements before and/or after the field element.

At the process 618, a skin name is provided. At the process 620, a skin is saved in the form of a folder whose name is the same as the skin name and/or matches with the skin name generated at the process 618. For example, the folder includes the one or more images and/or icons generated at the process 612, the one or more cascading style sheet files generated at the process 614, and the one or more dynamic html templates generated at the process 616. In another example, the skin is saved into the skin database 210.

As discussed above and further emphasized here, FIG. 6 is merely an example, which should not unduly limit the scope of the claims. One of ordinary skill in the art would recognize many variations, alternatives, and modifications.

In one embodiment, some or all processes of the method 600 are performed by at least a computer or a processor directed by a code. In another embodiment, some or all processes of the method 600 are performed according to at least instructions included by or stored in a computer-readable medium in a computer program product. In yet another embodiment, at least some processes of the method 600 are performed automatically. In yet another embodiment, at least some processes of the method 600 is performed by the system 100. For example, the method 600 is performed by the server 110 and a user interface (UI) designer 160 as shown in FIGS. 1 and 6.

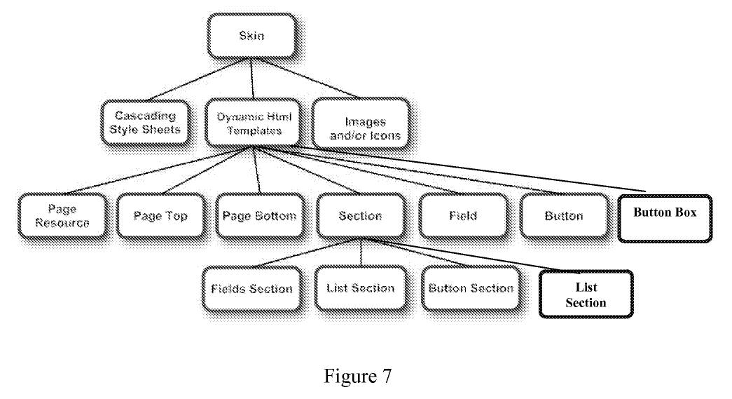

FIG. 7 is a simplified diagram showing components of a skin that is generated by the method 600 according to an embodiment of the present invention. This diagram is merely an example, which should not unduly limit the scope of the claims. One of ordinary skill in the art would recognize many variations, alternatives, and modifications.

The skin is identified by a skin name, and includes one or more style sheets, one or more images and/or icons, and one or more dynamic html templates. For example, the one or more style sheets are described in one or more cascading style sheet files respectively. In another example, the one or more cascading style sheet files are stored in a folder, which also includes the one or more images and/or icons and one or more dynamic html templates. The name of the folder is the same as the skin name and/or matches with the skin name.

As shown in FIG. 7, the one or more dynamic html templates are of one or more types. For example, the one or more types of dynamic html templates include page resource template, page top template, page bottom template, section template, field row template, field box template, and/or button box template. In one embodiment, a section template may be a fields section template, a table section template, a buttons section template, or a list section template.

In another embodiment, a page top template defines the display for the top area of a user interface page. In yet another embodiment, a page bottom template defines the display for the bottom area of a user interface page. In yet another embodiment, a section template defines the display for the border of a section. In yet another embodiment, a field row template or a field box template defines the display for the border of a field. In yet another embodiment, a page resource template defines the JavaScript and common style sheets (CSS) that should be imported for a user interface page.

As discussed above and further emphasized here, FIG. 7 is merely an example, which should not unduly limit the scope of the claims. One of ordinary skill in the art would recognize many variations, alternatives, and modifications. For example, the one or more types of dynamic html templates include page body template. In one embodiment, a page body template defines the display for the body area and the title area of a user interface page.

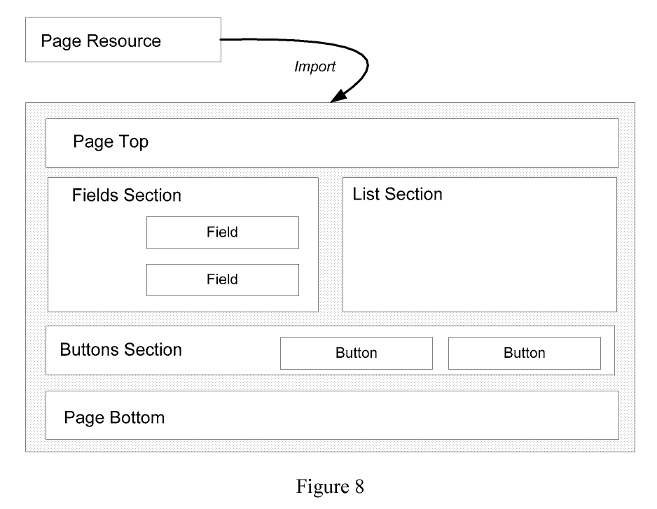

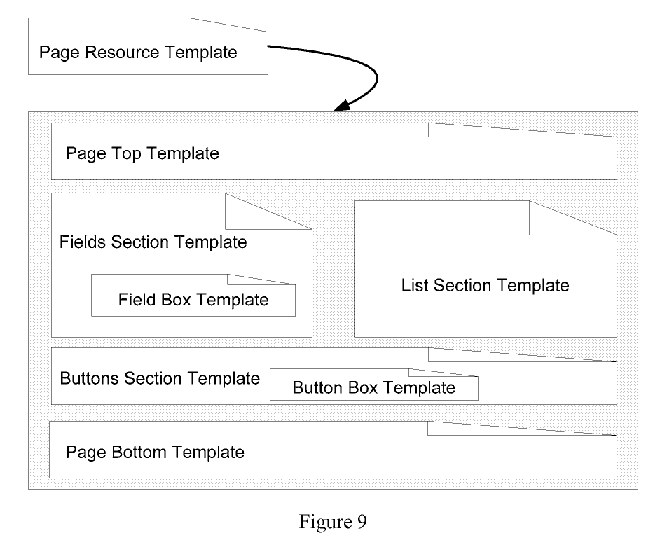

FIGS. 8 and 9 are simplified diagrams showing a match between certain user interface controls and certain dynamic html templates as parts of a skin that is generated by the method 600 according to an embodiment of the present invention. This diagram is merely an example, which should not unduly limit the scope of the claims. One of ordinary skill in the art would recognize many variations, alternatives, and modifications.

As shown in FIG. 8, the user interface, for example, includes at least a page resource control, a page top control, a fields section control, a field box control, a list section control, a buttons section control, a button box control, and a page bottom control. These controls match with a page resource template, a page top template, a fields section template, a field box template, a list section template, a buttons section template, a button box template, and a page bottom template, respectively, as shown in FIG. 9.

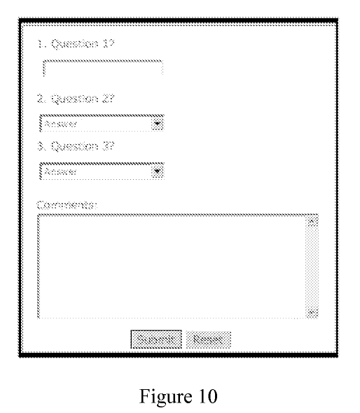

FIGS. 10, 11, and 12 are simplified diagrams showing user interface (UI) elements outputted by the method 400 according to certain embodiments of the present invention. These diagrams are merely examples, which should not unduly limit the scope of the claims. One of ordinary skill in the art would recognize many variations, alternatives, and modifications.

Specifically, FIGS. 10, 11, and 12 show different sets of outputted UI elements by the method 400 with the same set of imported UI elements. As shown in FIG. 10, the imported UI elements are not decorated by any skin, and they are exported at the process 460 and outputted at the process 492.

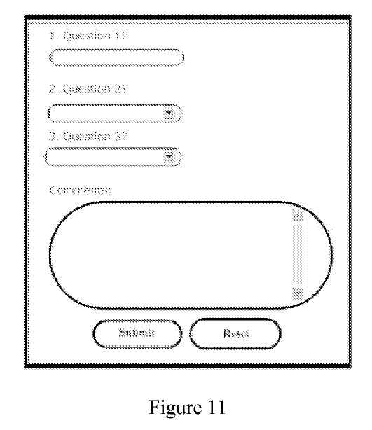

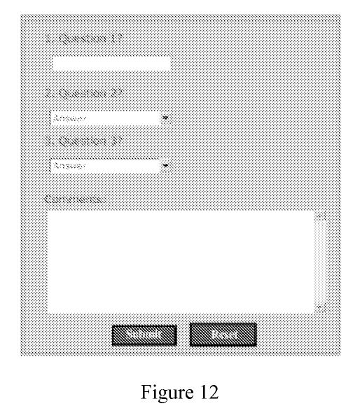

As shown in FIG. 11, the imported UI elements are decorated by one set of invoked UI templates at the process 480, exported at the process 490, and outputted at the process 492. As shown in FIG. 12, the imported UI elements are decorated by another set of invoked UI templates at the process 480, exported at the process 490, and outputted at the process 492.

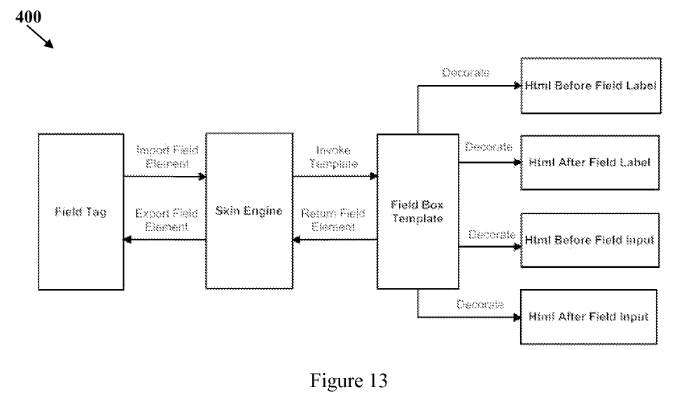

FIG. 13 is a simplified diagram showing an exemplary application of the method 400 for displaying one or more user interfaces on one or more remote devices according to an embodiment of the present invention. This diagram is merely an example, which should not unduly limit the scope of the claims. One of ordinary skill in the art would recognize many variations, alternatives, and modifications. The method 400 includes the process 410 for receiving a URL request, the process 420 for invoking a UI script that includes a field tag, the process 430 for importing a skin name and one or more UI elements that include one or more field elements, and the process 440 for loading a skin by the skin name. The skin includes one or more field box templates. Additionally, the method 400 includes the process 450 for determining availability of the skin. For example, the skin is determined to be available based on the skin name. Moreover, the method 400 includes the process 470 for invoking one or more UI templates including the one or more field box templates and the process 480 for decorating the one or more UI elements including the one or more field elements. For example, the process 480 includes decorating the one or more field elements with html before field label, html after field label, html before field input, and/or html after field input.

Also, the method 400 includes the process 490 for returning and exporting the one or more UI elements with the skin. For example, the exported one or more UI elements include the decorated one or more field elements. Additionally, the method 400 includes the process 492 for outputting the one or more UI elements. For example, the outputted one or more UI elements include the decorated one or more field elements.

Although the above has been shown using a selected group of processes for the method 400, there can be many alternatives, modifications, and variations. For example, the processes 440 and 450 are combined. Other processes may be inserted to those noted above. Depending upon the embodiment, the sequence of processes may be interchanged with others replaced. As an example, some or all processes of the method 400 are performed by a computer or a processor directed by a code. In another example, some or all processes of the method 400 are performed according to instructions included by or stored in a computer-readable medium in a computer program product. In yet another example, the method 400 is performed automatically. In yet another example, the method 400 is performed by the system 100. Further details of these processes are found throughout the present specification.

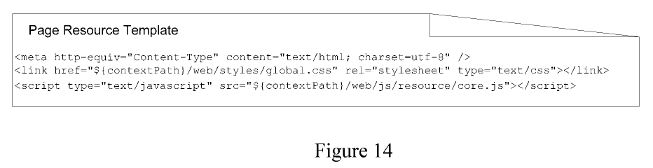

FIGS. 14-21 are simplified diagrams showing computer codes for various dynamic html templates that can be used for a skin generated by the method 600 according to certain embodiments of the present invention. These diagrams are merely examples, which should not unduly limit the scope of the claims. One of ordinary skill in the art would recognize many variations, alternatives, and modifications.

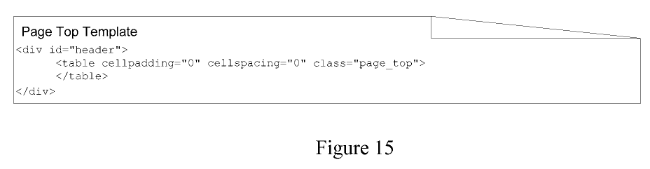

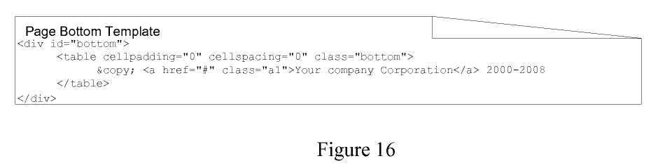

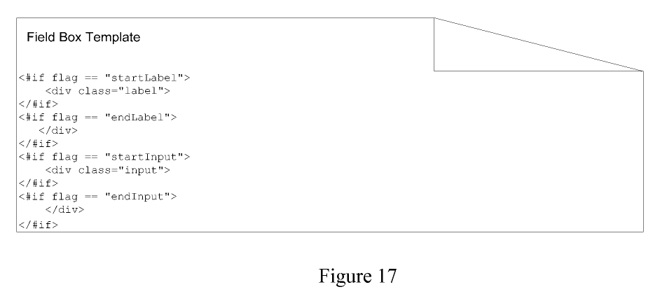

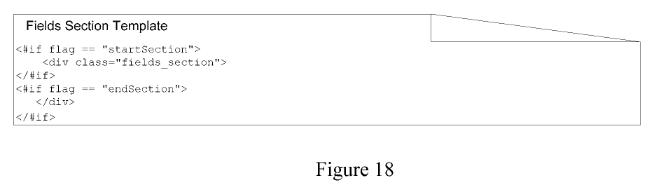

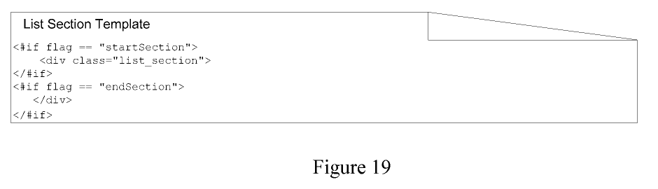

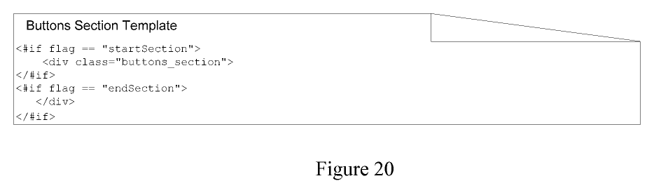

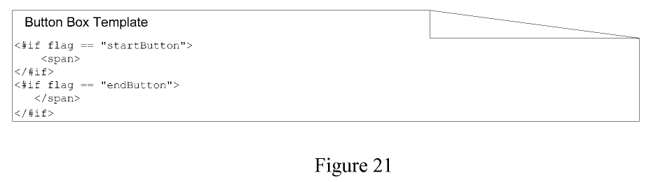

For example, FIG. 14 shows computer codes for a page resource template. In another example, FIG. 15 shows computer codes for a page top template. In yet another example, FIG. 16 shows computer codes for a page bottom template. In yet another example, FIG. 17 shows computer codes for a field box template. In yet another example, FIG. 18 shows computer codes for a fields section template. In yet another example, FIG. 19 shows computer codes for a list section template. In yet another example, FIG. 20 shows computer codes for a buttons section template. In yet another example, FIG. 21 shows computer codes for a button box template.

Certain embodiments of the present invention provide a system and/or a method for creating a skin engine that can enable a user to create a desired look and feel for a web application. For example, at run phase, the skin engine searches for a skin by a given skin name and then decorates the imported UI elements if the skin is found.

According to another embodiment, a method for displaying a user interface on a remote device includes receiving a first signal from a remote device by a computer server. The first signal is associated with a uniform resource locator request. The computer server includes at least a user interface engine and a skin engine. Additionally, the method includes running a user interface script by the user interface engine, importing to the skin engine from the user interface engine at least a skin name and one or more user interface elements based on at least information associated with the user interface script, and determining by the skin engine, availability of a skin based on at least information associated with the skin name. The skin corresponds to a skin folder with a folder name, and the folder name corresponds to the skin name. The folder includes at least one or more dynamic html templates. Moreover, the method includes, if the skin is determined to be available, decorating the one or more user interface elements by the skin engine based on at least information associated with the one or more dynamic html templates, and sending a second signal from the computer server to the remote device. The second signal is associated with the one or more decorated user interface elements for displaying a first user interface on the remote device. For example, the method is implemented according to the method 400 and/or the method 500.

In another example, the skin folder further includes one or more style sheet files, and one or more images and/or icons. In yet another example, the remote device is a computer, a mobile phone, or a personal data assistant device. In yet another example, the process for receiving a first signal from a remote device by a computer server includes receiving the first signal through at least the Internet. In yet another example, the process for receiving a first signal from a remote device by a computer server includes receiving the first signal through at least a wireless network. In yet another example, the method also includes if the skin is determined to be available, invoking by the skin engine the one or more dynamic html templates. In yet another example, the method also includes if the skin is determined to be available, exporting from the skin engine to the user interface engine at least the one or more decorated user interface elements. In yet another example, the method also includes if the skin is determined to be unavailable, exporting from the skin engine to the user interface engine the one or more user interface elements without skin, the one or more exported user interface elements being the same as the one or more imported user interface elements respectively, and sending a third signal from the computer server to the remote device, the third signal being associated with the one or more user interface elements without skin for displaying a second user interface on the remote device. In yet another example, the method also includes attempting to load the skin by the skin engine based on at least information associated with the skin name.

In yet another example, a combination of the process for attempting to load the skin by the skin engine and the process for determining by the skin engine availability of a skin includes attempting to load the skin from a cache memory based on at least information associated with the skin name, and determining availability of the skin in the cache memory. Additionally, the combination of the process for attempting to load the skin by the skin engine and the process for determining by the skin engine availability of a skin includes if the skin is determined to be unavailable in the cache memory, attempting to load the skin from a skin database based on at least information associated with the skin name, checking validity of the skin name, determining availability of the skin in the skin database, and if the skin is determined to be available in the skin database, retrieving the skin from the skin database and saving the skin in the cache memory.

In yet another example, the method also includes if the skin is determined to be available in the cache memory, decorating the one or more user interface elements by the skin engine based on at least information associated with the one or more dynamic html templates. In yet another example, the method also includes if the skin is determined to be available in the skin database, decorating the one or more user interface elements by the skin engine based on at least information associated with the one or more dynamic html templates. In yet another example, the method also includes if the skin is determined to be unavailable in the skin database, exporting from the skin engine to the user interface engine the one or more user interface elements without skin, the one or more exported user interface elements being the same as the one or more imported user interface elements respectively, and sending a third signal from the computer server to the remote device, the third signal being associated with the one or more user interface elements without skin for displaying a second user interface on the remote device. In yet another example, the one or more dynamic html templates include at least one dynamic html template selected from a group consisting of a page resource template, a page top template, a page bottom template, a page body template, a section template, a field row template, a field box template, and a button box template. In yet another example, the section template is selected from a group consisting of a fields section template, a table section template, a buttons section template, and a list section template.

According to another embodiment, a computer server for displaying a user interface on a remote device includes a user interface engine, a skin engine, and a skin database coupled to the skin engine. The user interface engine is configured to receive a first signal associated with a uniform resource locator request from a remote device, and run a user interface script. The skin engine is configured to import from the user interface engine at least a skin name and one or more user interface elements based on at least information associated with the user interface script, and determine availability of a skin based on at least information associated with the skin name. The skin corresponds to a skin folder with a folder name, and the folder name corresponds to the skin name. The skin folder includes at least one or more dynamic html templates. Additionally, the skin engine is further configured to, if the skin is determined to be available, decorate the one or more user interface elements based on at least information associated with the one or more dynamic html templates. Moreover, the user interface engine is further configured to, if the skin is determined to be available, send a second signal associated with the one or more decorated user interface elements for displaying a first user interface on the remote device. For example, the computer server is implemented according to the server 110 as shown in FIGS. 1, 2, and/or 3.

In yet another example, the skin engine includes an input/output access module, a validity checker module coupled to at least the input/output access module, a decorator module coupled to at least the input/output access module, and a template manager module coupled to at least the validity checker module and the decorator module. In yet another example, the skin folder further includes one or more style sheet files, and one or more images and/or icons. In yet another example, the skin engine is further configured, if the skin is determined to be available, invoke the one or more dynamic html templates. In yet another example, the skin engine is further configured to, if the skin is determined to be available, export to the user interface engine at least the one or more decorated user interface elements. In yet another example, the user interface engine is further configured to, if the skin is determined to be unavailable, send a third signal associated with the one or more imported user interface elements without skin for displaying a second user interface on the remote device. In yet another example, the one or more dynamic html templates include at least one dynamic html template selected from a group consisting of a page resource template, a page top template, a page bottom template, a page body template, a section template, a field row template, a field box template, and a button box template. In yet another example, the section template is selected from a group consisting of a fields section template, a table section template, a buttons section template, and a list section template.

According to yet another embodiment, a computer program product includes a computer readable medium including or storing instructions for displaying a user interface on a remote device. The computer readable medium includes or stores one or more instructions for receiving information associated with a uniform resource locator request from a remote device, one or more instructions for running a user interface script, one or more instructions for transferring at least a skin name and one or more user interface elements based on at least information associated with the user interface script, and one or more instructions for determining availability of a skin based on at least information associated with the skin name. The skin corresponds to a skin folder with a folder name, and the folder name corresponds to the skin name. The skin folder includes at least one or more dynamic html templates. Additionally, the computer readable medium includes or stores one or more instructions for, if the skin is determined to be available, decorating the one or more user interface elements based on at least information associated with the one or more dynamic html templates, and outputting information associated with the one or more decorated user interface elements for displaying a user interface on the remote device. For example, the computer program product is implemented according to FIGS. 1, 2, 3, 4, and/or 5.

Many benefits are achieved by way of the present invention over conventional techniques. Certain embodiments of the present invention provide a skin engine and define a skin with a skin name and a skin folder. For example, the skin folder includes at least one or more dynamic html templates. In another example, the skin engine can decorate imported user interface elements with the skin and output the decorated user interface elements.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for displaying a user interface on a remote device, the method comprising:
receiving a first signal from a remote device by a computer server, the first signal being associated with a uniform resource locator request, the computer server including at least a user interface engine and a skin engine;
running a user interface script by the user interface engine;
importing to the skin engine from the user interface engine at least a skin name and one or more user interface elements based on at least information associated with the user interface script;
determining by the skin engine, availability of a skin based on at least information associated with the skin name, the skin corresponding to a skin folder with a folder name, the folder name corresponding to the skin name, the skin folder including at least one or more dynamic html templates;
if the skin is determined to be available,
decorating the one or more user interface elements by the skin engine based on at least information associated with the one or more dynamic html templates; and
sending a second signal from the computer server to the remote device, the second signal being associated with the one or more decorated user interface elements for displaying a first user interface on the remote device.

2. The method of claim 1 wherein the skin folder further includes one or more style sheet files, and one or more images and/or icons.

3. The method of claim 1 wherein the remote device is a computer, a mobile phone, or a personal data assistant device.

4. The method of claim 1 wherein the process for receiving a first signal from a remote device by a computer server includes receiving the first signal through at least the Internet.

5. The method of claim 1 wherein the process for receiving a first signal from a remote device by a computer server includes receiving the first signal through at least a wireless network.

6. The method of claim 1, and further comprising if the skin is determined to be available, invoking by the skin engine the one or more dynamic html templates.

7. The method of claim 1, and further comprising if the skin is determined to be available, exporting from the skin engine to the user interface engine at least the one or more decorated user interface elements.

8. The method of claim 1, and further comprising if the skin is determined to be unavailable,
exporting from the skin engine to the user interface engine the one or more user interface elements without skin, the one or more exported user interface elements being the same as the one or more imported user interface elements respectively; and
sending a third signal from the computer server to the remote device, the third signal being associated with the one or more user interface elements without skin for displaying a second user interface on the remote device.

9. The method of claim 1, and further comprising attempting to load the skin by the skin engine based on at least information associated with the skin name.

10. The method of claim 9 wherein a combination of the process for attempting to load the skin by the skin engine and the process for determining by the skin engine availability of a skin includes:
attempting to load the skin from a cache memory based on at least information associated with the skin name;
determining availability of the skin in the cache memory;
if the skin is determined to be unavailable in the cache memory,
attempting to load the skin from a skin database based on at least information associated with the skin name;
checking validity of the skin name;
determining availability of the skin in the skin database;
if the skin is determined to be available in the skin database,
retrieving the skin from the skin database; and
saving the skin in the cache memory.

11. The method of claim 10, and further comprising if the skin is determined to be available in the cache memory, decorating the one or more user interface elements by the skin engine based on at least information associated with the one or more dynamic html templates.

12. The method of claim 10, and further comprising if the skin is determined to be available in the skin database, decorating the one or more user interface elements by the skin engine based on at least information associated with the one or more dynamic html templates.

13. The method of claim 10, and further comprising if the skin is determined to be unavailable in the skin database,
exporting from the skin engine to the user interface engine the one or more user interface elements without skin, the one or more exported user interface elements being the same as the one or more imported user interface elements respectively; and
sending a third signal from the computer server to the remote device, the third signal being associated with the one or more user interface elements without skin for displaying a second user interface on the remote device.

14. The method of claim 1 wherein the one or more dynamic html templates include at least one dynamic html template selected from a group consisting of a page resource template, a page top template, a page bottom template, a page body template, a section template, a field row template, a field box template, and a button box template.

15. The method of claim 14 wherein the section template is selected from a group consisting of a fields section template, a table section template, a buttons section template, and a list section template.

16. A computer server for displaying a user interface on a remote device, the computer server comprising:
a user interface engine;
a skin engine; and
a skin database coupled to the skin engine;
wherein the user interface engine is configured to:
receive a first signal associated with a uniform resource locator request from a remote device; and
run a user interface script;
wherein the skin engine is configured to:
import from the user interface engine at least a skin name and one or more user interface elements based on at least information associated with the user interface script;
determine availability of a skin based on at least information associated with the skin name, the skin corresponding to a skin folder with a folder name, the folder name corresponding to the skin name, the skin folder including at least one or more dynamic html templates; and
if the skin is determined to be available, decorate the one or more user interface elements based on at least information associated with the one or more dynamic html templates;
wherein the user interface engine is further configured to, if the skin is determined to be available, send a second signal associated with the one or more decorated user interface elements for displaying a first user interface on the remote device.

17. A computer server of claim 16 wherein the skin engine comprises:
an input/output access module;
a validity checker module coupled to at least the input/output access module;
a decorator module coupled to at least the input/output access module; and
a template manager module coupled to at least the validity checker module and the decorator module.

18. The computer server of claim 16 wherein the skin folder further includes one or more style sheet files, and one or more images and/or icons.

19. The computer server of claim 16 wherein the skin engine is further configured, if the skin is determined to be available, invoke the one or more dynamic html templates.

20. The computer server of claim 16 wherein the skin engine is further configured to, if the skin is determined to be available, export to the user interface engine at least the one or more decorated user interface elements.

21. The computer server of claim 16 wherein the user interface engine is further configured to, if the skin is determined to be unavailable, send a third signal associated with the one or more imported user interface elements without skin for displaying a second user interface on the remote device.

22. The computer server of claim 16 wherein the one or more dynamic html templates include at least one dynamic html template selected from a group consisting of a page resource template, a page top template, a page bottom template, a page body template, a section template, a field row template, a field box template, and a button box template.

23. The computer server of claim 22 wherein the section template is selected from a group consisting of a fields section template, a table section template, a buttons section template, and a list section template.

24. A computer program product including a computer readable medium including instructions for displaying a user interface on a remote device, the computer readable medium comprising:
one or more instructions for receiving information associated with a uniform resource locator request from a remote device;
one or more instructions for running a user interface script;
one or more instructions for transferring at least a skin name and one or more user interface elements based on at least information associated with the user interface script;
one or more instructions for determining availability of a skin based on at least information associated with the skin name, the skin corresponding to a skin folder with a folder name, the folder name corresponding to the skin name, the skin folder including at least one or more dynamic html templates; and
one or more instructions for, if the skin is determined to be available,
decorating the one or more user interface elements based on at least information associated with the one or more dynamic html templates; and
outputting information associated with the one or more decorated user interface elements for displaying a user interface on the remote device.
